(19) United States
(12) Patent Application Publication
(10) Pub. No.: US 2005/0261806 A1
(43) Pub. Date: Nov. 24, 2005

(54) Electronic traffic control system for the manipulation of motor vehicles for civil or emergency purposes

(76) Inventors: Jean Guy Canie, Toronto (CA); Jean Robert Canie, Toronto (CA)

Correspondence Address: Jean Robert Canie, 78 Holly ST. 1501, Toronto, ON, M4S 3C9, CA

(21) Appl. No.: 10/724,414

(22) Filed: May 20, 2004

(51) Int. Cl. G06F 17/00

(52) U.S. Cl. 701/2; 701/36

(57) ABSTRACT

This invention relates to the control of motor vehicles through the use of a collimated laser beam allowing a remote entity to cause a motor vehicle to slow to a safe stop in an emergency situation. The collimated laser beam uses specialty data encryption techniques which prevent unauthorized use of the apparatus.

This invention relates to emergency control systems, and more particularly to such systems for engine-driven vehicles where remote controlling intelligence is transmitted by means of highly user directional, user adjustable narrow to wide beam laser waves in user selective pattern. This invention also relates to the encryption of the transmitted signal and the decryption of the received signal.

This invention also relates to a hand-held transmitter for the wireless transmitting of user adjustable signals to manipulate a moving vehicle, comprising a signal generating device, with an adjustable energy source, and an adjustable hand-operable transmitter and a remotely programmable receiver.

### BACKGROUND OF THE INVENTION

Hand held transmitters which operate with limited power, limited effective range, and limited user adjustable function are known and operate for example with an electric power supply in the form of a 9 volt battery, and allow a garage door fitted with an appropriate receiver, to be opened or closed by means of electrical propulsion energy with the aid of a transmitted signal (for example, German Gerbrauchsmusterschrift 76 26 730) and

In particular such hand-held transmitters are of low power omni-directional and not encrypted. It should be noted in this regard that modern electronics make it possible to build programmable transmitters with user adjustable wave patterns. The transmitters can also transmit highly directional user adjustable from narrow to wide wave patterns. The signals transmitted from such transmitters can be encrypted with proprietary mathematical encryption algorithms providing a high degree of signal security. The receivers which receive said transmitted encrypted signals can be made to receive and decrypt said signals which have been encrypted with the proprietary mathematical encryption algorithms providing a high degree of signal security.

### SUMMARY OF THE INVENTION

The jurisdiction in which the invention may be used varies and as such may have a bearing on which functions may be employed by the controlling operator, therefore among the several objects of this invention may be noted the provision of a remote control system in which a specific vehicle may be controlled by the controlling operator using any one of the following means or a combination thereof a) the vehicle may be slowed, b) the vehicle may be slowed and stopped, c) the vehicle emergency lights may be made to flash, d) a vehicle sound warning device such as the horn may be activated to emit sound waves, e) a remote tracking geographical positioning sensor or transponder, may be activated by a controlling operator at a position remote from the vehicle by means of highly user directional, user adjustable laser beam adjustable from narrow to wide beam pattern of laser waves;
the provision of a remote control system of the class described which employs a highly user directional laser carrier and in which the receiver component thereof is sensitive to the laser signal which are modulated in accordance with a definitive pre-selected encryption pattern;
the provision that the receiver employs the use of encryption logic allowing the receipt only of pre-selected laser signals of a pre-selected pattern which conform to an encryption standard at least equivalent to the standard known as the (D.E.S.) Data Encryption Standard;
the provision that the receiver can be remotely programmed and contains proprietary encryption and decryption algorithms that conform to and provides access protection at least equivalent to the standard known as (D.E.S.) Data Encryption Standard;
the provision that the transmitter contains a proprietary encryption algorithm that conforms to and provides access protection at least equivalent to the standard known as (D.E.S.) Data Encryption Standard;
the provision that the transmitter can be pre-programmed by the controlling operator or similar person of authority using a logic key system or a public key or similar alternative encryption key standard;
the provision that the transmitter is small enough to be portable so such as to be used by one person;
the provision that the said transmitter logic and access codes can be programmed with the proprietary encryption code by an authority on site or remotely through a communication carrier such as and through the use of a modulator/demodulator scheme attached to a communication network hereinafter described;
the provision of a remote control system in which a specific vehicle or a group of vehicles consisting of one or more vehicles at the option of the controlling operator may be controlled by the controlling operator using any one of the following means or a combination thereof a) the vehicle may be slowed, b) the vehicle may be slowed and stopped, c) the vehicle emergency lights may be made to flash, d) a vehicle sound warning device such as the horn may be activated to emit sound waves, e) a remote tracking geographical positioning sensor or transponder, may be activated by a controlling operator at a position remote from the vehicle by means of highly user directional, user adjustable laser beam adjustable from narrow to wide beam pattern of laser waves, notwithstanding the desire of the operator of said controlled vehicle may be to the contrary;
the provision of such a remote system in which the vehicle functions and the circuitry are not damaged or destroyed and may be restored to their original state and the engine may be restarted by the transmission of encrypted logic after predetermination by the controlling operator or other such authority;
the provision of methods for controlling or disabling as the case may be of a specific motor vehicle or a specific group of motor vehicles from a remote position either in close proximate to the said vehicle or vehicles or at a great distance, to the limit of the line of sight from the controlling operator;
the provision of the controlling operator to selectively adjust the dimension of the waves transmitted thus disabling or controlling one or more or a combination of functions of one or more vehicles as the case may be predetermined by the controlling operator either in close proximate to said vehicle or vehicles or at great distances, to a limit of the line of sight from the controlling operator from a remote position;
the provision that motor vehicles so equipped may be interfaced to existing traffic control systems which control traffic lights; and
the provision of the controlling operator may remotely by computer execute a pre-defined mathematical algorithm rapidly and selectively adjust the dimension of the waves and the direction of the transmission thus disabling or controlling one or more or a combination functions of one or more vehicles as the case may be predetermined by the controlling operator either in close proximate to said vehicle or vehicles or at great distances, to a limit of the line of sight from the controlling operator from a remote position.

Other objects and features will be in part apparent and in part pointed out hereinafter.

The invention accordingly comprises the constructions and methods hereinafter described, the scope of the invention being indicated in the following claims.

In the accompanying drawings, in which several of various possible embodiments of the invention are illustrated,

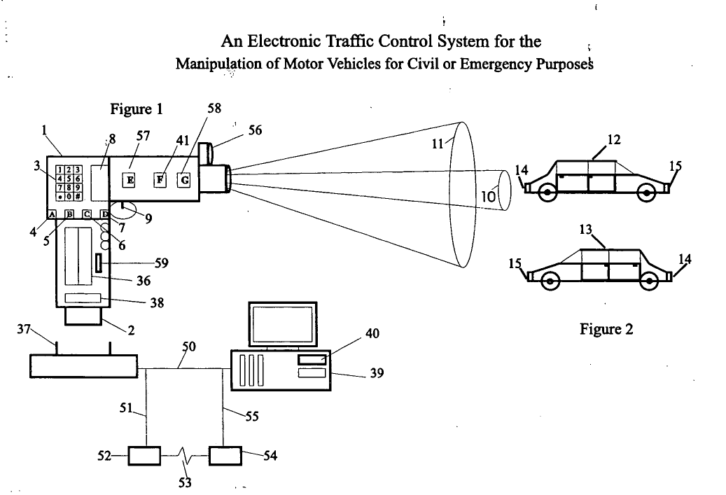

FIG. 1 Is a perspective view of the transmitter equipped with the control system of the present invention;

FIG. 2 Is a perspective view of two vehicles equipped with the control system of the present invention;

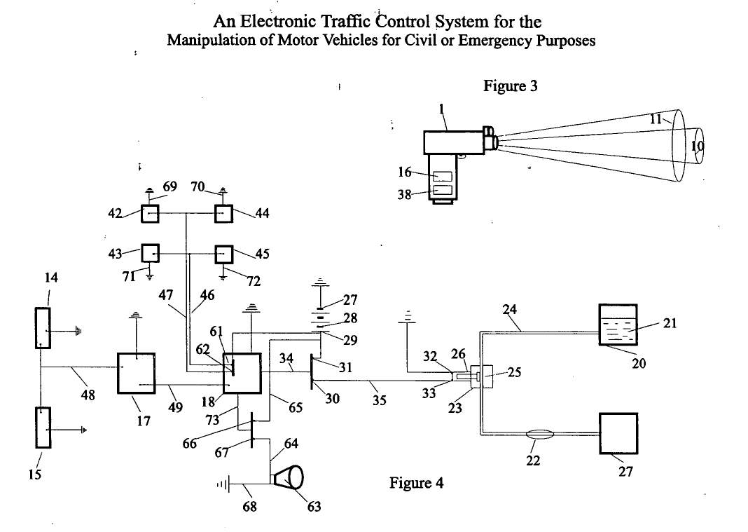

FIG. 3 Is a block diagram of the transmitting portion of the remote control system shown in FIG. 1, and

FIG. 4 Is a block diagram of one portion of another embodiment of the present invention.

Corresponding reference characters indicate corresponding parts throughout the several views of the drawings.

### DETAILED DESCRIPTION OF THE INVENTION

It has become increasingly apparent within the past few years that a reliable, portable and economical system for selectively slowing, warning the public and selectively safely stopping one or more moving vehicles from a remote position would be highly desirable and beneficial traffic and law enforcement tool. High speed projectiles commonly known as “bullets”used by law enforcement to halt vehicles are both a public concern and pose in some instances a public safety hazard as are high speed vehicle chases across the roadways and highways.

It is also increasingly apparent that traffic common to most growing cities can be controlled remotely.

In accordance with the present invention such a system has been developed which permits an authorized person or agency to halt one or more or any vehicle (even contrary to the wish of the driver thereof) which is equipped with a component portion of the remote control system disclosed herein. Thus a police officer equipped with a transmitting portion component of the present invention and located at a fixed position near a roadway or in another vehicle moving along a road can selectively halt one or more vehicles at the same time, equipped with the receiver portion and associated components of the present invention.

Referring now more particularly to the drawings which illustrate preferred embodiments of the present invention, reference numerals 12 and 13 designates a controlled vehicle and reference numeral 1 designates a controlling transmitter each of which is conventionally constructed and operated except that they are modified as described below to include components of the remote control system of this invention.

Securely mounted on the vehicles referenced by the numerals 12 and 13 and directed generally rearwardly and frontwardly are laser wave receivers referenced by the numerals 14 and 15.

These receivers referenced by the numerals 14 and 15 receive the transmitted signal from the transmitter 1. As can be seen in FIG. 4, the signal from the receivers 14 or 15 is received by either receiver 14 or 15 where it is transmitted to the demodulator and decrypted flash BIOS 17 by conductor 48. Thus when an electromagnetic radiation signal of laser light in the visible spectrum which is modulated, coded and encrypted in a pre-selected encryption pattern at a frequency which matches the decryption algorithm contained in the flash BIOS 17 which is received and detected by the receiver 14 or 15, then the flash BIOS 17 will initiate a logical subroutine in which the electronic ignition 18 of the vehicle will receive logical instructions from the flash BIOS 17 across conductor 49 which will cause the valve 23 to reduce the flow of fuel 21 through the fuel line 24 to the vehicle engine 19, thus progressively slowing the vehicle.

Also upon decoding of the encryption signal the electronic ignition relay 18 may activate the vehicles four emergency lights 42, 43, 44, 45, through the conductor 46 and 47 thus completing a circuit from the battery 28 to the emergency lights 42, 43, 44, 45 to the chassis ground.

It should be noted here that the particular manner in which the individual components of the receiver 14 and 15 are mounted therein has no direct bearing on this invention, and accordingly said components are described only so far as required to show their operation in the present invention in combination with other units.

Operatively mounted in the vehicles 12 or 13 is an engine 19 to which a fuel 21 from a fuel tank 20 is fed through a fuel line 24 by a fuel pump 22. Interposed between the fuel tank 20 and the fuel pump 22 is a normally open, electrically closable fuel valve 23 which provides a passage between an inlet port 25, which is directly coupled to the fuel line 24.

The valve 23 integrally includes an electrically operated means 26 such as a solenoid valve, for blocking the passage of fuel through the inlet port 25 upon the applying of voltage across a pair of terminals 32, 33.

The valve 23 is governed by a time delay which is programmed into the flash BIOS 17 which allows the reopening of the valve upon receipt of another predetermined encrypted electromagnetic signal being received from the controlling operator. The solenoid operated valve at 23 is designed to interrupt the flow of fuel to engine 19 upon energization by the voltage of battery 28.

In the making of the electrical connections required in the vehicle 12 and 13 the positive terminal 29 of the battery 28 is connected to contact 31 of the electronic ignition relay 18 through a conductor 34. Contact 30 of the electronic ignition relay 18 is connected to the terminal 33 of the valve 23 through a conductor 35, and terminal 32 of said valve is chassis grounded to the vehicle 12 or 13 in a manner similar to terminal 27 of the battery 28 to complete the circuit.

The transmitting portion 1 of the control system is shown in FIG. 1 as comprising a portable laser transmitter which may be user adjusted to project a laser beam with variable degrees of beam dimensional width and electromagnetic intensity. The laser beam is a modulated collimated laser radiation beam. It will be understood that this transmitter is also adjustable in power so that it may be used over substantial distances to the limit of a distance of the line of sight of the controlling operator to said vehicle or vehicles.

The transmitter is powered by a rechargeable power source such as a power source as nickel cadmium batteries 36 which allow the transmitter to be portable.

In operation, the transmitter 1 is initially connected by 2 an electrical connector such as a Revised Standard 232 communications connector 37 connected either directly to a computer 39 through conductor 50 and through conductor 51 to the telecommunications data circuit such as a modulator/demodulator 52 which is connected to a data communications carrier 53 to a remote data circuit such as a modulator/demodulator 54 to conductor 55 to a computer 39 to a controlling program 40.

It should be noted here that the particular manner in which the RS232 connector 2 and 37 are connected through conductor 51, modulator/demodulator 52, communications carrier 53, modulator/demodulator 54, conductor 55, to computer 39 and computer program 40 are methods of conventional construction, the manner in which such components are interfaced as to such interfacing has no direct bearing on this invention, and accordingly said component is described only so far as required to show its operation in the present invention in combination with other units.

Connecting the transmitter in thus manner allows for the programming of the transmitter flash BIOS chip 38 by the computer program 40 contained within the computer 39 the program 40 which contains the proprietary mathematical algorithm whereupon the connection thereto of transmitter 1 and the running of the program 40 issues the controlling operator, a police officer, a similar authority or the flash BIOS chip 38 of transmitter 1 is programmed thereby or the controlling operator is issued with a secret transmitter 1 activation code which will remain valid for the duration of a predetermined amount of time such as in the case of the police officer for a period of one eight hour working shift. The computer program encrypts the access code using a standard at least the equivalent to the standard known as Data Encryption Software (D.E.S.) and stores the access codes in a programmable flash BIOS chip 38 located within the transmitter 1.

### THE EMBODIMENTS OF THE INVENTION IN WHICH AN EXCLUSIVE PROPERTY OR PRIVILEGE IS CLAIMED ARE DEFINED AS FOLLOWS

Prior to use the transmitter 1 must be activated either by the controlling operator entering the secret activation code originally received through the computer 39 issued by the computer program 40 by typing the secret activation code into the numeric keypad 3 or by the transmitting of the correct activation key code from the computer program 40 through the computer 39 which transmits controlling data through the conductor 50 to the RS232 connector 2 and 37 to the flash BIOS 38 or such data transmitted to the transmitter 1 transmitted as a public or private key through the digital conductor 55 to the modulator/demodulator 54 which is connected through the carrier 53 to the modulator/demodulator 52 which is connected to the RS232 communications port 2 and 37 through the conductor 51 to the transmitter 1.

A descending logical counter a logical timer algorithm contained within the flash BIOS 38 deactivates the transmitter after a predetermined amount of time such as within five minutes in-the case of usage by a police officer after the transmitter has been activated necessitating the controlling operator such as a police officer to reenter the secret activation code.

The encryption of the access to programming the BIOS 38, 17 and the encryption of the modulated carrier laser beam and said secret access code to a standard equivalent to the standard known as the Data Encryption Standard (D.E.S.) provides the security necessary to prevent unauthorized usage of the equipment.

The buttons identified by the numerals 4 and 5 provide quick access to two pre-programmed functions. Button 4 adjusts the dimensional radius of the encrypted collimated laser beam 11 by narrowing the dimensional radius of the beam 11 from forty-five degrees dimensional radius to one degree of dimensional radius in one degree increments. Button item 5 adjusts the encrypted collimated laser beam 10 from one degree of dimensional radius to forty-five degrees 11 of dimensional radius in one degree increments. The laser beam 10 and the laser beam 11 are the one and the same beam. The numeral 10 represents the beam in its one degree dimensional radius position while 11 represents the beam in its 45 degree dimensional radius the forty-five degree position.

The liquid crystal display 8 provides the controlling operator with a visible menu of controlling options or choices. The options or choices identified and labeled thereon are one through five in which the controlling operator selects the corresponding numeral by depressing the corresponding numeric key on the numeric keypad 3. The options or choices available include any one of the following means of controlling a vehicle or a group of vehicles or any combination thereof 1) the vehicle may be slowed, 2) the vehicle may be slowed and stopped, 3) the vehicle emergency lights be made to flash, 4) a vehicle sound device such as the horn may be activated to emit sound waves, 5) a remote tracking geographical positioning sensor or transponder, which may be activated and the vehicle or vehicles may be tracked remotely or by orbital geographical positioning satellite, by which using the numeric keypad 3 and the enter key 5 the controlling operator may select, choose and confirm the intended use thereof of one or more or a combination thereof of the abovementioned functions by depressing the corresponding numeric key on the keypad 3 and depressing 5 the choice thereby being programmed into the flash BIOS chip 38.

It should be noted here that the particular manner in which the individual components of the geographical positioning sensor are of conventional construction and as to such construction has no direct bearing on this invention, and accordingly said components are described only so far as required to show their operation in the present invention in combination with other units.

Item 6 allows the controlling operator to manually place the transmitter 1 into the programming mode in which the transmitter 1 may either receive programming or allow the transmitter 1 to be programmed remotely as herein described.

A data encryption algorithm conforming at least to the standard known as the Data Encryption Standard (D.E.S.) is contained within a flash BIOS chip 38 and BIOS chip 16 which provides encryption of the coded laser transmitter signals. Flash BIOS 16 acts as backup storage to flash BIOS chip 38 in the case of chip failure. It should be noted here that the particular manner in which the individual component the flash BIOS chip 16 provides backup to flash BIOS chip 38 has no direct bearing on this invention, and accordingly said component is described only so far as required to show its operation in the present invention in combination with other units.

The receiver 14 or 15 and the transmitter 1 are adjusted to receive and transmit respectively compatible coded encrypted signals. The vehicles 12 or 13 may be operated independently until such time as the controlling operator of the transmitter desires that vehicle 12 or 13 be halted or the controlling operator desires to activate one or more of the operative functions pre-selected as displayed in the liquid crystal display 8 or pre-programmed into the flash BIOS 38 by the computer program 40 whereupon the controlling operator activates the switch 9, by depressing the switch or remotely by activating the pre-programmed flash BIOS 38 causing energization of the transmitter 1 and directing the electromagnetic energy of the collimated laser beam coded and encrypted radiation at the receiver 14 or 15 which is located on the vehicle 12 or 13 or alternatively multiple vehicles.

The flash BIOS chip 17 may also be reprogrammed to accept alternate unique encryption codes such as proprietary public and private key algorithms at least equivalent to the standard described by the Data Encryption Standard (D.E.S.) which can be programmed by the transmitter 1 and the program 39 can issue via the computer 40 can issue to the transmitter 1 public and private key codes up to an equivalent 1024 times 1024 bit resolution providing unique encryption coding based upon a proprietary encryption mathematical algorithm.

The transmitter may be controlled activated or programmed by remote means such as from land, sea or air, inclusive of line of sight by orbital satellite laser transmission using a user adjustable narrow or wide encrypted laser beam.

The receiver may be activated or programmed by remote means such as from land, sea or air, inclusive of line of sight by orbital satellite laser transmission using a user adjustable narrow or wide encrypted laser beam.

As the beam of laser energy strikes the receiver 14, or 15 the receiver supplies the input of flash BIOS 17 with the encrypted coded signal. The receiver supplies said signal to the decryption module a flash BIOS chip 17, which decrypts the signal through its pre-programmed encryption/decryption algorithm according to a standard at least equivalent to the Data Encryption Standard commonly known as (D.E.S.). Accordingly the electronic ignition relay 18 is actuated by the output. Upon such actuation, the contacts 30, 31 close and electrical power from the battery 28 is applied to the electrically operated valve 23. When so energized valve 23 interrupts the flow of fuel in time controlled increments to engine 19 and the vehicle 12 or 13 comes to a stop.

The algorithm used to interrupt fuel flow, consists of the computer program programming a mathematical counter in the flash BIOS 17 which will at descending predetermined timed increments based upon the vehicle speed, such as beginning at one minute intervals for a vehicle be traveling at 120 kilometers per hour, the flash BIOS chip 17 will issue a signal across the conductor 49 to the electronic ignition relay 18 which will issue a signal of appropriate variable electrical signal strength across contact 30 via conductor 35 to the closing terminals 32 and 33 causing valve 23 to interrupt the fuel of flow by closing the solenoid 26 by fifty percent based upon such appropriate variable strength electrical signal upon receipt of which at each at the presentation of the successive signal the valve 23 will close by an additional fifty percent until a null balance condition occurs in the flash BIOS 17 counter and until the fuel flow is completely shut off whichever is greater.

It should be noted here that the particular manner in which the solenoid 26 is constructed as a variable electrical signal receiver has no direct bearing on this invention, and accordingly said components are described only so far as required to show their operation in the present invention in combination with other units.

The reopening of the valve 23 may be accomplished by the re-activation of receiver 12 or 13 by the transmitter while depressing button 41.

The impingement of laser radiation upon the receiver 12 or 13 other than that modulated and encrypted in accordance with the pre-selected pattern will not actuate valve 23. Thus, random radiation or random laser radiation will not affect operation of the receiver to slow or halt the vehicle.

The activation and recording of digital video signals of the vehicle or vehicles controlled or to be controlled by the operator is accomplished by the depression of 58 whereupon a digital camera 56 employing a charged coupled device digitally captures and records on recordable digital optical disk 59 digital video signals for subsequent retrieval.

It should be noted here that the particular manner in which the digital video, the charged coupled device and the recordable optical drive are constructed has no direct bearing on this invention, and accordingly said components are described only so far as required to show their operation in the present invention in combination with other units.

The activation of 57 causes said digital video signals to be transmitted via flash BIOS 38 logic through the RS232 connector 2 and 37 directly to the computer 40 or remotely via modulator/demodulator by means as herein before described.

The activation of the sound device 63 such as the horn may be similarly activated remotely by the program 40 and the computer 39 either connected directly or remotely through the modulator/demodulator scheme herein before described where the flash BIOS chip 17 actuates relay 18 and the conductor 73 relay closes terminals 66 and 67 thus completing the circuit thereby providing positive voltage along conductor 64 to the sound device which completes the circuit which terminates at ground on conductor 68.

The activation of the flashing emergency lights is accomplished by the relay located at the terminals 61 and 62 closing completing the circuit from the voltage received along conductor 60 through the emergency lights 42, 43, 44, 45 to ground at 69, 70, 71, and 72 respectively. It should be noted that the actual flashing circuit relay is self contained within the respective light assemblies identified by 42, 43, 44 and 45 and as to such relays have no direct bearing on this invention, accordingly said relay components are described only so far as required to show their operation in the present invention in combination with other units.

It should be noted here that the particular manner in which flash BIOS 38, 16 and 17 are constructed are based upon conventional construction methods and have no direct bearing on this invention, and accordingly said components are described only so far as required to show their operation in the present invention in combination with other units.

It should be noted here that the particular manner in which the specific program, the algorithms and functions contained therein which parse the logic and access the encryption and decryption functions herein before referenced are also the subject of © Copyright 1988 and 1997 claimed by the inventors.

In view of the above, it will be seen that the several objects of the invention are achieved and other advantageous results attained.

As various changes could be made in the above constructions and methods without departing from the scope of the invention, it is intended that all matter contained in the above description or shown in the accompanying drawings shall be interpreted as illustrative and not in a limiting sense.

1. A remote control system for an automotive vehicle having an engine with an ignition circuit and a liquid fuel supply system and a laser radiation receiver mounted on said vehicle adapted to supply an electrical output signal only upon the reception of a encrypted and coded signal modulated in accordance with a pre-selected encrypted pattern a portable laser transmitter located at a position remote from said receiver for selectively transmitting an encrypted user adjustable highly directional narrow to wide laser signal beam modulated in accordance with said pre-selected encryption pattern, means responsive to said output signal connected to the vehicle engine for disabling it upon reception of said encrypted radiation signal modulated in an pre-selected encryption pattern and delay means associated with said disabling means for deactivating said disabling means by the controlling operator or other such authority whereby the vehicle can be slowed safely pursuant to timer logic and safely stopped over a fixed period of time by transmitting such a modulated encrypted user selected narrow or wide beam unidirectional radiation signal to said receiver, and the vehicle may be restarted by the controlling operator or similar authority.

2. A remote control system as set forth in claim 1 in which the disabling means comprises an electrical relay having a set of electrical contacts series connected in the ignition circuit for opening said ignition circuit.

3. A remote control system as set forth in claim 1 in which the disabling means includes an electrically actuated solenoid valve connected in said fuel system for interrupting the flow of fuel to the engine.

4. A remote control system for an automotive vehicle having an engine with a liquid fuel supply system, said remote control system comprising an encrypted laser radiation receiver mounted on said vehicle adapted to supply an electrical output signal only upon reception of a user selected adjustable narrow to wide beam unidirectional encrypted laser signal encrypted to at least the standard known as the Data Encryption Standard (D.E.S.), modulated in accordance with a pre-selected encrypted pattern, a laser transmitter located at a position remote from said receiver and adapted to selectively transmit a laser signal encrypted to at least the standard known as the Data Encryption Standard, modulated in accordance with a pre-selected encrypted pattern, a electrically actuated solenoid valve connected in said fuel supply system for interrupting, in response to an output signal supplied by said receiver, the flow of liquid fuel to said engine whereby the engine of said vehicle can be progressively disabled by the transmitting of a encrypted laser signal from said transmitter, and delay means associated with said electrically activated solenoid valve for de-actuating said solenoid valve by the controlling operator or other authority after the actuation thereof whereby liquid fuel is permitted to flow to said engine by the controlling operator or similar authority.

5. A remote control system for an automotive vehicle having an engine with a liquid fuel supply system comprising a receiver mounted on said vehicle adapted to supply an electrical output signal only upon reception of a encrypted narrow or wide beam signal modulated in accordance with an encrypted pre-selected pattern, a transmitter located at a position remote from said receiver and adapted to selectively transmit a encrypted signal modulated in accordance with said encrypted pre-selected pattern, an electrically actuated solenoid valve connected in said fuel supply system for interrupting, in response to an output signal supplied by said receiver, the flow of liquid fuel to said engine whereby the engine of said vehicle may be disabled by the transmitting of a signal from said transmitter, and delay means associated with said electrically actuated interrupting valve adapted to de-actuate said interrupting valve upon receipt of an encrypted de-actuation signal received from the transmitter by the controlling operator or similar authority whereby liquid fuel is permitted to flow to said engine upon receipt of said signal.

6. A logic algorithm consisting of subroutines specifically for said purposes as set forth in claim in 1 and 4 as it applies to the encryption and decryption of the radiation signals and the pre-selected modulated encryption pattern as transmitted by said transmitter and received by said receiver equivalent to the standard known as the Data Equipment Standard (D.E.S.).

7. A remote control system in which a specific vehicle may be controlled by using any one of the following means or a combination thereof a) the vehicle may be slowed, b) slowed and stopped, c) the emergency lights be made to flash, d) the horn may be activated to emit sound waves, e) activation of a sensor or transponder which may be activated remotely by a controlling operator or by a geographical orbital satellite from which a geographical positioning and tracking system may track the vehicle or vehicles from a position remote from the vehicle the activation and manipulation of one or more or a combination of these functions by means of encrypted highly user directional, user adjustable laser beam adjustable from narrow to wide beam pattern of laser waves.
